(19) United States
(12) Patent Application Publication
(10) Pub. No.: US 2005/0140706 A1
(43) Pub. Date: Jun. 30, 2005

(54) Method for patching element defects by ink-jet printing

(76) Inventors: Kevin Cheng, Hsinchu (TW); Chih-Jian Lin, Hsinchu (TW); Wan-Wen Chiu, Hsinchu (TW); Jhih-Ping Lu, Hsinchu (TW); Fu-Kang Cheng, Hsinchu (TW); Jane Chang, Hsinchu (TW)

Correspondence Address: BIRCH STEWART KOLASCH & BIRCH, PO BOX 747, FALLS CHURCH, VA, 22040-0747, US

(21) Appl. No.: 10/844,435

(22) Filed: May 13, 2004

(30) Foreign Application Priority Data
Dec. 26, 2003 (TW) 092137238

(51) Int. Cl. B41J 25/308; B41J 29/38

(52) U.S. Cl. 347/8; 347/16

(57) ABSTRACT

A method for patching element defects by ink-jet printing includes steps of identifying all defects of the element by image analysis and obtaining an optimal ink-jet printing path of the ink-jet head. The ink-jet head repairs all defects of the element with the shortest distance along the optimal patching path. Moreover, the ink-jet head repairs all defects of the element in a stable manner so as to increase the yield rate.

### BACKGROUND OF THE INVENTION

1. Field of the Invention

The invention generally relates to method for patching defects of an element, and in particular relates to a method for patching defects of an element by ink-jet printing.

2. Related Art

Ink-jet printing is a delicate, high-repetitive process being applied in the electronic industry of precision elements for achieving the manufacturing requirements and trend of automated, minimized, low-cost, less process and less environmental impact. It is applicable to the printings of precision elements of different materials. However, the ink-jet printing applied on high-resolution film elements, such as micro lenses array and polymer light emitter diodes (PLED), requires highly precise positioning for ejecting ink droplets on predetermined positions. Moreover, the solvent (water or other organic solvent) in the ink droplets adhered to the substrate has to vaporize before the film forms. But the uniformity of the film is often influenced by the physical condition of vaporization.

There are solid (the substrate), liquid (the ink droplet) and vapor (the vaporized solvent) phases around the ink droplet and the substrate. The energy in the solid and liquid contact areas is less (heat dissipation is faster) than the energy in the liquid and vapor contact areas. Further, the vapor pressure in the solid and liquid contact areas is less than the vapor pressure in the liquid and vapor contact areas. So, the rim of the ink drop dries faster than the central portion that makes the center of the film lower than the rim, and a so-called “coffee ring” is generated. The uneven film greatly influences the function of the precision element. Therefore, the inhomogeneous film is a major problem of ink-jet printing process. The secondary problem is the phase separation during the film drying. The aforesaid problems influence the yield and quality of the element production. Especially, the ink-jet printing process is hard to improve the resolution for high precision elements.

The surface treatment of the substrate is also critical. If the surface is not well treated, the hydrophilic and hydrophobic property of the surface are different, then the ink droplet ejected on the surface is broken by the uneven cohesion between the ink droplet and the substrate. Therefore, there are defect holes formed. For example, a hole on a polymer light emitter diode causes current leakage. The defects greatly influence the elements. Other problems, such as substrate contamination, deconcentrated ink droplets and clogged ink-jet head, etc., also cause printing defects.

Therefore, it is a demand to check and patch the defects on the elements in order to improve the quality and yield. Besides, it needs to keep the stability of ink-jet printing during patch period. In U.S. Pat. No. 5,847,720, a process for repairing includes steps of providing an indication by an operator to a checking system; marking of defective blocks by a microscopic optics positioning system; displaying on a checking screen of said defective blocks; recognizing characteristics of the defects by the operator; defining a repair sequence transmitted to the checking system, and printing by selective deposition of ink ejected by a single nozzle having the color corresponding to the defective blocks.

### SUMMARY OF THE INVENTION

The object of the invention is to provide a method for patching defects of an element by ink-jet printing. The method first detects all defect points; calculating an optimal patching path; then patching with ink-jet printing according to the optimal path.

A method for patching element defects by ink-jet printing according to the invention applies an optimal patching path so that the ink-jet head travels with a shortest distance that also saves time and prevents the nozzles of the ink-jet head from being clogged since a longer waiting of non-ejection. The method includes steps of identifying all defects of the element and obtaining the optimal ink-jet printing path of the ink-jet head. The ink-jet head repairs all defects of the element at a shortest distance along the optimal patching path. Any a larger or wider defect that requires several times of ejection and movement of the ink-jet head is identified as a plurality of defect positions. The step of identifying the defect positions is processed through image analysis.

The process of calculating an optimal (shortest) ink-jet printing patching path according to the defect positions includes the following steps. Establishing a plurality of defect coordinates (Xi,Yi), i=1 to n; referring on a reference coordinate (X₀,Y₀) of the nozzle of the ink-jet head, and calculating the distances Ri between the reference point and the plurality of defect positions, Ri=((Xi−X₀)²+(Yi−Y₀)²)^{1/2}; selecting a defect position with a minimal Ri value as the next patching position. The aforesaid steps are repeated to get the further next patching position when the ink-jet head moves and patches a patching position. Another manner is to find out the order of all the patching positions. When a defect position is selected, the patching position is set as the ink-jet head position for calculating the relative distances and selecting a next patching position, the steps are repeated till all the positions are arranged as an optimal patching path.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a flowchart of a method of the invention;

FIG. 2 is a flowchart of an image analysis process in the invention;

FIG. 3 is an explanatory view of an image template with defects to be processed by the invention;

FIG. 4 is an explanatory view of arranging an optimal patching path for the template of FIG. 3;

FIG. 5 is a pre-oscillation voltage chart for activating the ink-jet head in the process of the invention.

### DETAILED DESCRIPTION OF THE INVENTION

The invention provides a method for patching element defects by ink-jet printing. Defects usually take place in ink-jet printing processes include: (1). the lattice structure of element breaking to lead to overflow and ink mixed, (2). substrates are contaminated to lead to attach particle, (3). ink-jet printing generated satellite drops, (4). nozzles of print head was clogged, (5). ink-jet printing unstable, (6). the surface is not well treated, the hydrophilic and hydrophobic property of the surface different to lead fluid separation, (7). the polar characteristic of ink repels with bank. The disclosed patching process is mainly for repairing the defects of No. 4˜No. 7, mainly in the under-filled problem. The method includes steps of identifying all defects of the element by image analysis and obtaining an optimal ink-jet printing path of the ink-jet head. The ink-jet head repairs all defects of the element at a shortest distance along the optimal patching path. The detection and patching are automated so as to improve the quality and yield of the element.

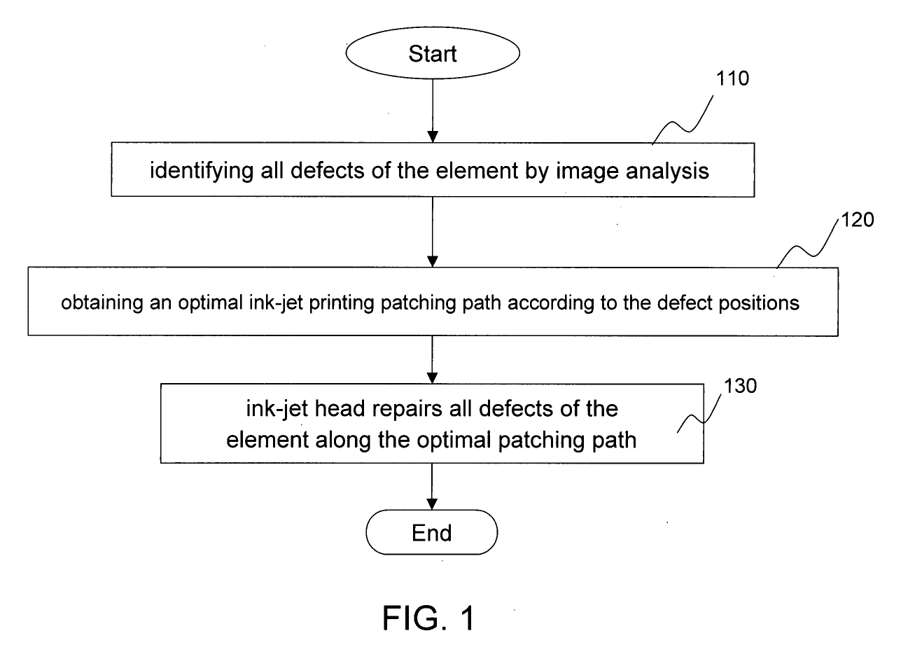

FIG. 1 shows a flowchart of the invention. The method for patching the element defects by ink-jet printing includes the following steps. First, identify all defects of the element by image analysis (step 110). Obtain an optimal ink-jet printing patching path according to the defect positions (step 120). Finally, the ink-jet head repairs all defects of the element along the optimal patching path (step 130).

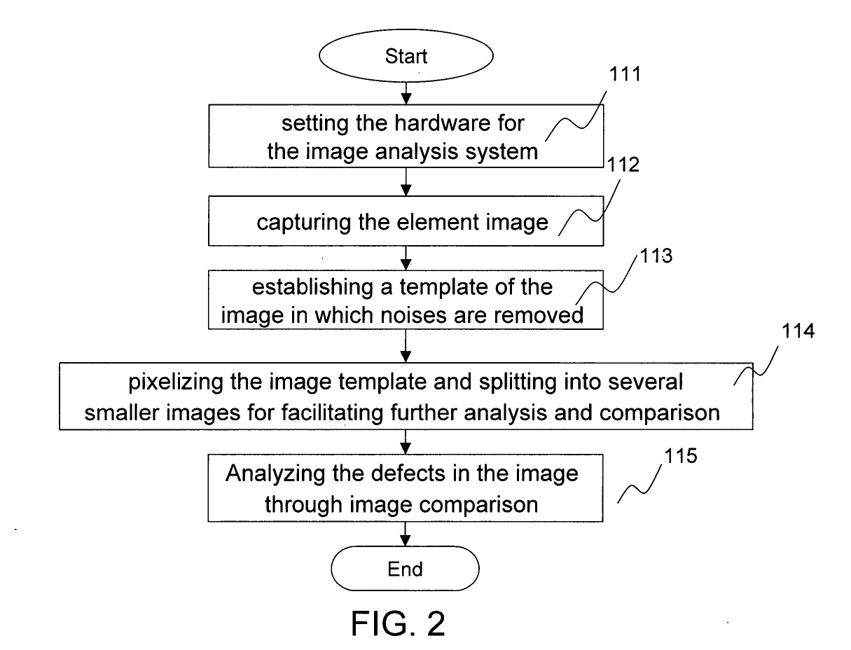

The detailed process of image analysis for the defect positions is shown in FIG. 2. The steps are: setting the hardware for the image analysis system (step 111); capturing the image of the element (step 112); establishing a template of the image in which noises are removed (step 113); pixelizing the image template and splitting into several smaller images for facilitating further analysis and comparison (step 114) and analyzing the defects in the image through image comparison (step 115).

The hardware setting for the image analysis system includes settings of the CCD camera, light source, ratio, focus, etc. for obtaining a clear element image. The element image requires a pre-process to establish a stable image template in which distortions are calibrated. The deviations of physical measurements among images are compared and compensated.

In an embodiment of the invention, the process of establishing an image template includes the following steps. Remove unnecessary image portions through a threshold of image segmentation. Rotating and aligning the image to a right position for improving recognition. The edge of the image is detected and calibrated to correct the distortion according to physical measurements. Then, pre-processing increase the signal to noise ratio. The pre-process includes noise removal, color range conversion, increasing contrast, binary transformation and extract color planes. The image background is filtered through image subtraction and comparison of the image template to a standard template image.

The step of pixelizing the image template is to split the image template into a plurality of smaller images for the sake of improving recognition rate and saving time of defect analysis.

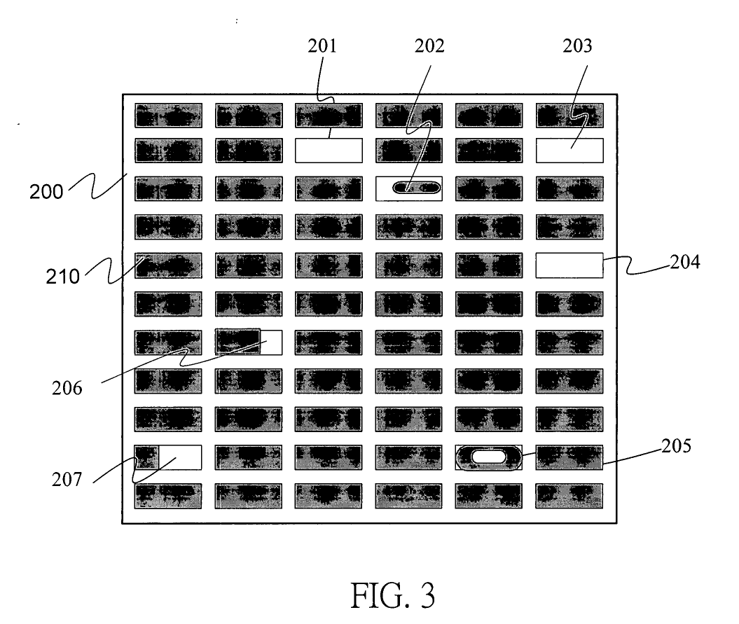

The defect analysis is to compare the template images with a standard template and to identify the defects of less print, missed print, overflow or splash. The patching process of the invention is mainly for repairing the defects of less or missed prints. When a defect is identified, the position coordinate and the type of defect are recorded for the patching afterward. The defect analysis includes steps of: identifying the defects through template comparison; calculating the defect area; calculating the necessary patching positions for each defect; and setting the patching positions as defect positions. As shown in FIG. 3, in an image template of an element 200 having a plurality of patterns 210, there are several defects 201, 202, 203, 204, 205, 206 and 207 of different types occur.

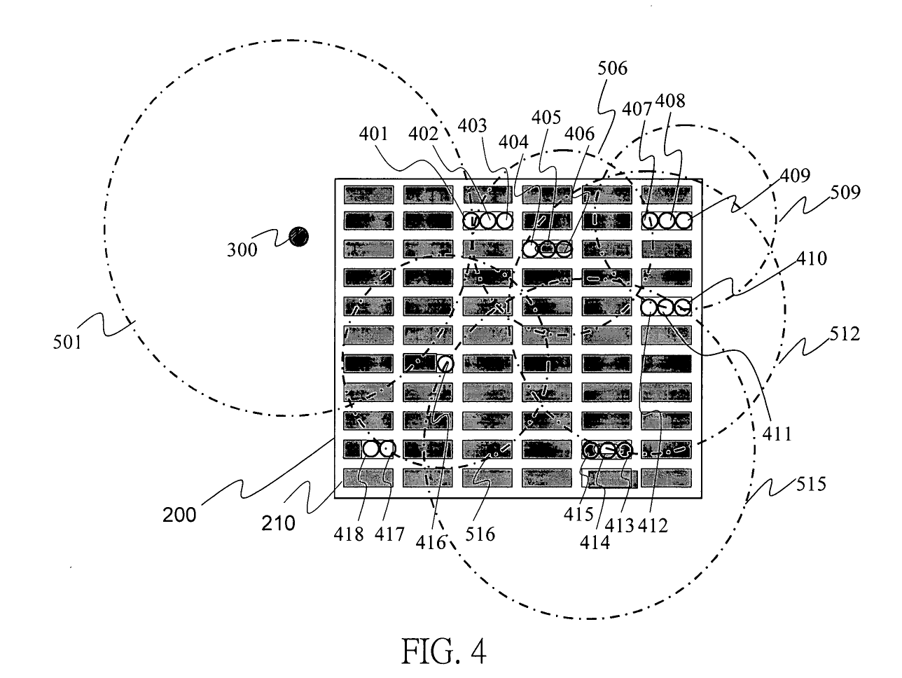

The invention processes the defect positions into an optimal patching path so that the ink-jet head travels along a shortest path to finish the printing and patching. FIG. 4 illustrates the calculation method by an example of the image template of FIG. 3. The nozzle position 300 of the ink-jet head is first identified. Centering on the nozzle position 300, a circle 501 can cover the nearest patching position 401. Then, adjacent to the position 401, the nearest patching positions are 402, 403 in sequence. Further, centering on the position 403, the nearest patching position 404 is obtained. The process proceeds and the sequential patching positions 401 to 418 are identified as an optimal patching path where several circles 506, 509, 512, 515 and 516 centering on the patching positions 406, 409, 412, 415 and 416 are checked for locating the next patching positions. In mathematical expression, for a plurality of defect coordinates (Xi,Yi), i=1 to n; referring on a reference coordinate (X₀,Y₀) of the nozzle of the ink-jet head, and calculating the distances Ri between the reference point and the plurality of defect positions, Ri=((Xi−X₀)²+(Yi−Y₀)^{1/2}, a defect position with a minimal Ri value is selected as the next patching position. For convenience of operation, the already selected or patched positions are labeled as “T” from original “F”. “F” means “false” of positions to be patched, and “T” means “true” of positions already selected or patched. For example, there are initially 18 positions in FIG. 4 to be patched. They are labeled as “F” before patching. When the ink-jet head prints and patches the first position 401, it is labeled as “T”. The aforesaid steps are repeated to get the further next patching position for the ink-jet head moving and patching sequentially till all the defect positions are labeled as “T”. The labeling process helps the marking of the patching positions, prevents from repeated calculation and help verification of finishing all the patching positions.

When applying in patching defects on polymer light emitter diodes, the highly evaporative and viscid ink is easy to dry in the nozzle during a longer idling time of non-printing. Because the solvent of the ink around the nozzle evaporates, the ink gets a higher viscosity and clogs the nozzle. Therefore, the invention provides the optimal patching path for shortening the idling time of the ink-jet head during traveling.

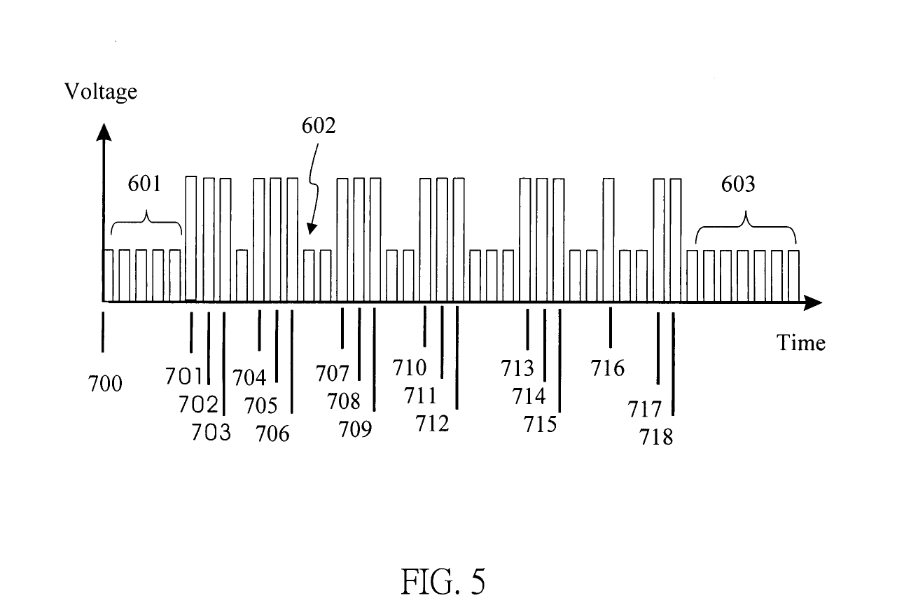

Moreover, the invention provides a pre-oscillation control to the ink-jet head for oscillating the ink in the nozzle and stabilizing the ink-jet printing. The oscillation helps the ink in the nozzle move back and forth, but the energy is less than ejection, so as to prevent the ink drying and blocking the nozzle. Referring to FIG. 4 and FIG. 5, during traveling of the ink-jet head from one patching position to another, there are oscillation voltage pulses 601 applied on the nozzle of the ink-jet head. The oscillation energy moves the ink in the nozzle and prevents it from drying. When the nozzle reaches the patching position 401, the nozzle receives an ejection voltage 701 and ejects an ink droplet to the defect position. For those patching positions 402, 403, . . . 418, the correspondent voltage pulses are 702, 703, . . . 718 respectively. Please note that for the adjacent patching positions, such as 401, 402 and 403, the printing pulses 701, 702 and 703 are also continuous because they are more stable. While, between the patching positions of a longer distance, such as between the patching positions of 406 and 407, there are a plurality of oscillation pulses 602 provided to prevent ink drying. Even after the patching, the oscillation pulses are maintained to prevent the nozzle from being clogged.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for patching element defects by ink-jet printing, comprising steps of:
identifying a plurality of defect positions on a element;
obtaining an optimal ink-jet printing patching path covering said defect positions in a shortest distance based on position of a nozzle of ink-jet head; and
printing and patching said defects along said optimal patching path.

2. The method for patching defects of an element by ink-jet printing according to claim 1, wherein said step of identifying a plurality of defect positions comprises steps of:
capturing an image of said element;
removing noise from said image and establishing an image template;
pixelizing said image template and splitting it into a plurality of smaller images; and
analyzing and obtaining said defect positions through comparison of said image template to a standard template.

3. The method for patching defects of an element by ink-jet printing according to claim 2, wherein said step of removing noise and establishing an image template comprises steps of:
removing unnecessary image portions through a threshold of image segmentation;
rotating and aligning said image to a right position and detecting edge and calibrating said image to comply with physical measurements;
pre-processing said image to remove noise; and
filtering background of said image through image subtraction and comparison of said image template to said standard template.

4. The method for patching defects of an element by ink-jet printing according to claim 3, wherein said step of pre-processing said image comprises noise removal, color range conversion, increasing contrast, binary transformation and extract color planes.

5. The method for patching defects of an element by ink-jet printing according to claim 2, wherein said step of analyzing and obtaining said defect positions comprises steps of:
identifying a plurality of defects through pattern matching;
calculating area of each defect;
calculating necessary patching positions for each defect; and
setting said patching positions as defect positions.

6. The method for patching defects of an element by ink-jet printing according to claim 1, wherein said step of obtaining an optimal ink-jet printing patching path covering said defect positions in a shortest distance comprises steps of:
a) establishing a plurality of defect coordinates (Xi,Yi), i=1 to n;
b) referring on a reference coordinate (X₀,Y₀) of said nozzle of ink-jet head, and calculating distances Ri between said reference point and said plurality of defect positions, Ri=((Xi−X₀)²+(Yi−Y₀)²)^{1/2}; and
c) selecting a defect position with a minimal Ri value as a next patching position.

7. The method for patching defects of an element by ink-jet printing according to claim 6, wherein said patching position is preset with coordinate of said nozzle and repeating said steps b) and c) for obtaining said next patching position till all defect positions are taken to form said optimal path.

8. The method for patching defects of an element by ink-jet printing according to claim 1, further comprises a step of labeling said defect positions to indicate patching status to speed up calculation in patch position.

9. The method for patching defects of an element by ink-jet printing according to claim 8, further comprises a step of checking said position labeling to verify finishing of said patching.

10. The method for patching defects of an element by ink-jet printing according to claim 1, further comprises a step of pre-oscillating ink in said nozzle and stabilizing said ink-jet printing.

11. The method for patching defects of an element by ink-jet printing according to claim 10, wherein said step of pre-oscillating is to provide pre-oscillating pulses to said nozzle with energy lower than an ejection voltage, while maintaining oscillation of ink in said nozzle to prevent ink from being dried and clogging said nozzle when said ink-jet head moving in said path between non-adjacent defect positions.
